(19) United States
(12) Patent Application Publication
(10) Pub. No.: US 2004/0042493 A1
(43) Pub. Date: Mar. 4, 2004

(54) System and method for communicating information among components in a nodal computer architecture

(76) Inventor: Darel N. Emmot, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/231,606

(22) Filed: Aug. 30, 2002

(51) Int. Cl. H04J 3/24

(52) U.S. Cl. 370/474

(57) ABSTRACT

The present invention is generally directed to a system and method for communicating information among components—e.g., from an originator node to a destination node, in a nodal computer architecture. In one embodiment, a method for communicating an information packet from an originator node to a destination node is provided. The method of this embodiment comprises splitting the information packet into a plurality of data segments, mapping the data segments to individual links extending between the originator node and the destination node, and reassembling the information packet at the destination node.

### BACKGROUND OF THE INVENTION

1. Field of the Invention

The present invention generally relates to computer systems, and more particularly to a novel system and method for communicating information among components in a nodal computer system.

2. Discussion of the Related Art

Multiprocessor computer systems often comprise a number of processing-element nodes connected together by an interconnect network. Such processing-element nodes typically include at least one processing element. The interconnect network transmits packets of information or messages between processing-element nodes. Multiprocessor computer systems having up to hundreds or thousands of processing-element nodes are typically referred to as massively parallel processing (MPP) systems. In a typical multiprocessor MPP system, the processing elements may be configured so that the system can directly address all of memory, including the memory of another (remote) processing element, without involving the processor at that processing element. Instead of treating processing element-to-remote-memory communications as an I/O operation, reads or writes to another processing element's memory are often accomplished in the same manner as reads or writes to the local memory.

In such multiprocessor MPP systems, the infrastructure that supports communications among the various processing-element nodes greatly affects the performance of the MPP system because of the level of communications required among processors.

Several different topologies have been proposed to interconnect the various nodes in such MPP systems, such as rings, stars, meshes, hypercubes, and torus topologies. Regardless of the topology chosen, design goals generally include a high communication bandwidth (i.e., large amount of content exchanged between nodes), a low inter-node distance, a high network bisection bandwidth and a high degree of fault tolerance. With regard to bisection bandwidth, it may be desired for the bisection bandwidth to exceed the product of the communication bandwidth and the average inter-node distance. Topologies are often characterized in terms of the maximum inter-node distance or network diameter: the paths with the shortest distance between two nodes that are farthest apart on the network are minimal paths. In this regard, inter-node distance is defined as the number of links occupied on the path from one node to another node.

Bisection bandwidth is the number of links connecting two halves of the network where the halves are selected as the two halves connected by the fewest number of links. It is this worst-case bandwidth that can potentially limit system throughput and cause bottlenecks. Therefore, it is a general goal of network topologies to maximize bisection bandwidth.

In a torus topology, a ring is formed in each dimension where information can transfer from one node, through all of the nodes in the same dimension and back to the original node. An n-dimensional torus, when connected, creates a n-dimensional matrix of processing elements. A bidirectional n-dimensional torus topology permits travel in both directions of each dimension of the torus. For example, each processing-element node in the 3-dimensional torus has communication links in both the + and − directions of the x, y, and z dimensions. Torus networks offer several advantages for network communication, such as increasing the speed of transferring information. Another advantage of the torus network is the ability to avoid bad communication links by sending information via a non-minimal path through the network. Furthermore, a toroidal interconnect network is also scalable in all n dimensions, and some or all of the dimensions can be scaled by equal or unequal amounts.

In a conventional hypercube network, a plurality of nodes are arranged in an n-dimensional cube where the number of nodes n in the network is equal to 2ⁿ. In this network, each node is connected to one other node in each dimension. The network diameter, the longest communications path from any one node on the network to any other node, is n-links. Conventional hypercube topology is a very powerful topology that meets many system design criteria. However, when used in large systems, the conventional hypercube has some practical limitations. One such limitation is the degree of fanout required for large numbers of nodes. As the degree of the hypercube increases, the fanout required for each node increases. As a result, each node becomes costly and requires larger amounts of silicon to implement.

Variations on the basic hypercube topology have been proposed, but each have drawbacks, depending on the size of the network. Some of these topologies suffer from a large network diameter, while others suffer from a low bisection bandwidth.

Historical topologies, such as hypercube and torus meshes, utilize aggregated links in multiple dimensions to yield bandwidth and connectivity. Reference is made to FIG. 1, which illustrates this general architecture. In this regard, FIG. 1 illustrates a nodal system having an originator node 12, a destination node 14, and a plurality of intermediate nodes 16. Links extending between the originator node 12 and the destination node 14 are made up of a relatively large number of channels that carry data from the originator to the destination in parallel fashion.

However, when multiple links are provided for individual nodes, this leads to a high pin count and poor bandwidth utilization (e.g., an increased number of underutilized links).

### SUMMARY OF THE INVENTION

To achieve certain advantages and novel features, the present invention is generally directed to a system and method for communicating information among components—e.g., from an originator node to a destination node, in a nodal computer architecture. In one embodiment, a method for communicating an information packet from an originator node to a destination node comprises splitting the information packet into a plurality of data segments, mapping the data segments to individual links extending between the originator node and the destination node, and reassembling the information packet at the destination node.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagram illustrating a nodal architecture of a prior art computer system, wherein messages or information may be communicated from an originator node to a destination node.

FIG. 2 is a diagram illustrating a nodal architecture of a computer system, wherein messages or information may be communicated from an originator node to a destination node, in accordance with one embodiment of the present invention.

FIG. 3 is a diagram illustrating an inventive nodal architecture, emphasizing intercommunicating links or communication channels and logic blocks configured to carry out certain functions.

FIG. 4 is a diagram illustrating certain portions of an example message packet passed among the nodes of the architecture of FIG. 3.

FIG. 5 is a diagram that illustrates the operation of an embodiment of disaggregation logic that resides at an example originator node.

FIG. 6 is a diagram that illustrates the operation of an embodiment of mapping logic that resides at an example originator node.

FIG. 7 is a diagram that illustrates the operation of an embodiment of reassembly logic that resides at an example destination node.

### DETAILED DESCRIPTION

Having summarized various aspects of the present invention above, reference will now be made in detail to the a preferred embodiment of the present invention. Before discussing details of a preferred embodiment, however, certain terms will first be defined. As used herein, the following terms should be accorded the following definitions, unless an alternative definition is implied from a contrary usage of the terms:

A CHANNEL is a minimal physical connection between nodes consisting of one or more conductors.

A LINK is one or more channels used to communicate messages among nodes.

A PATH is a sequence of communication links that a packet occupies or traverses as it is communicated from one node to another node.

A VIRTUAL LINK is a plurality of paths that a given message occupies or traverses as it is communicated from node to node.

One design goal has been to design a topology that is well-suited to applications requiring a large number of nodes; one that is scalable; and one that provides a high bisection bandwidth, a wide communications bandwidth, and a low network diameter.

Moreover, as systems increase the number of nodes, the number of channels required to support the hypercube topology significantly increases, resulting in higher system costs and manufacturing complexities. Therefore, it is desired that systems could be scaled to take advantage of more than one type of topology so that smaller systems and larger systems having divergent design goals related to topology architecture could be accommodated in one system design. Such design goals include a desire to optimize system performance while attempting to minimize overall system costs and to minimize manufacturing complexities.

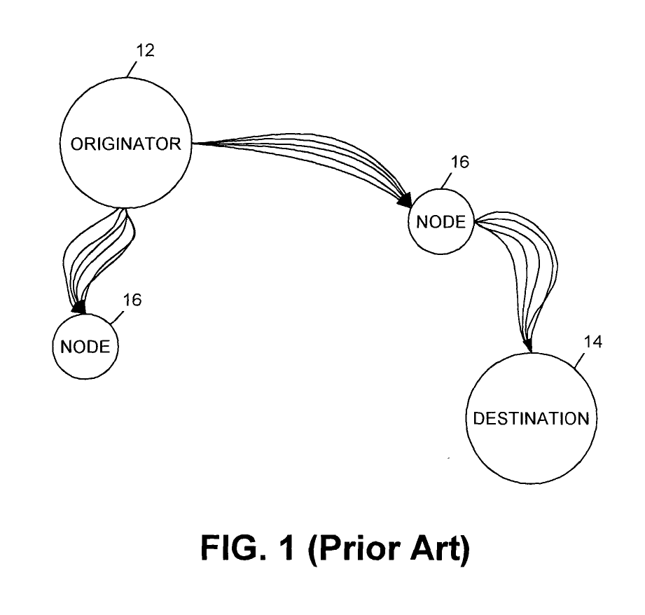

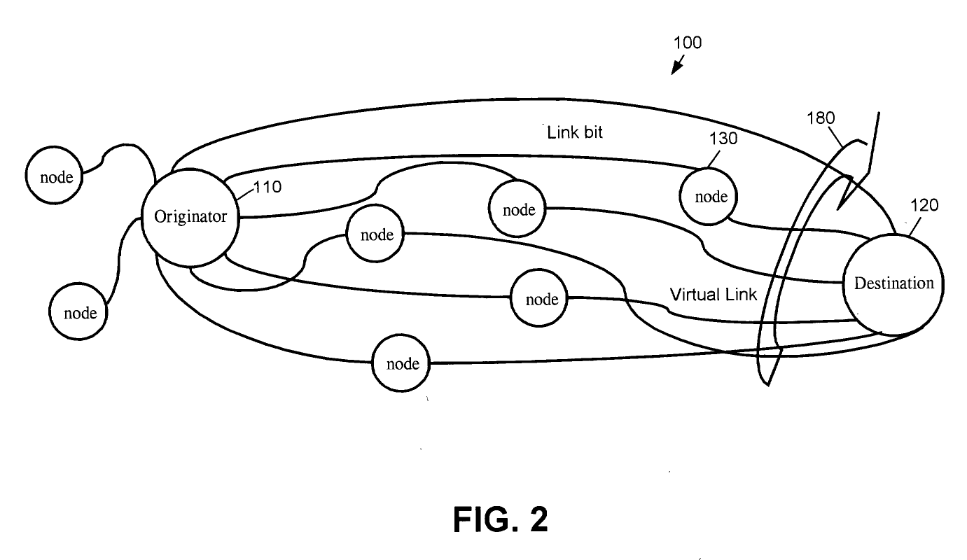

Reference is now made to FIG. 2, which is a diagram illustrating a general structure and topology of a system 100 constructed in accordance with a preferred embodiment of the present invention. Broadly stated, the preferred embodiment is directed to a computer system having a nodal architecture in which data or information is efficiently communicated among different nodes 110, 120, 130. In keeping with the diagram and nomenclature of that presented in FIG. 1, one node 110 has been designated as an originator node, while a second node 120 has been designated as a destination node. It will be appreciated that the terms “originator node,” “intermediate node,” and “destination node” are simply nomenclature used to reference the role of a given system node in relation to the communication of a given information packet. Intermediate nodes 130 are also illustrated. In this regard, any given system node will assume different roles (e.g., originator versus destination) for different messages. Consistent with the scope and spirit of the invention, the nodes 110, 120, and 130 may take on a variety of physical forms, such as memory controllers, microprocessors, input/output (I/O) controllers, etc.

In prior art systems, such as that illustrated in FIG. 1, a communication link between an originator node 12 and a destination node 14 was defined by a plurality of parallel conductors for carrying parallel bits of data. Data was communicated from the originator node to the destination node in a parallel fashion across the plurality of bits that make up one or more communication channels. In contrast, the preferred embodiment is directed to a nodal architecture that has a much more dispersed construction of its communication links (i.e., the links extending between the various nodes). One objective of the unique architecture of a preferred embodiment is to provide a smaller number of channels while maintaining low communication latency. Another objective is to simplify the skew management. As is known, skew management refers to the bit and symbol synchronization between channels that constitute a link for the purpose of maintaining the originator's temporal correlation of the channels at the destination.

By way of example, assume that the link width of the prior art system of FIG. 1 is 32-bits (i.e., there are 32 conductor pairs that comprise a single link extending between nodes). Further assume that there are five communication links extending from a given node. There would, therefore, be approximately 1280 total signal lines that are dedicated for communicating data across these communication channels (which includes power and ground signal lines). This does not include other signal lines that may be required for the particular integrated circuit component. As is known, this leads to an extremely high pin count for a given integrated circuit chip.

In contrast, the architecture of the preferred embodiment of FIG. 2 results in a much smaller number of channels (for example 64) that may extend or terminate at any given node. Recognizing the fact that as network diameter decreases, total bandwidth consumption decreases, it should be appreciated that the product of communication bandwidth and the average inter-node distance has an impact here. It should be further appreciated that channels are generally not constantly used for communication, and that communication bandwidth is often more a function of a short-term requirement to communicate a given message with low latency.

By splitting or disaggregating information messages to be communicated from an originator node 110 to a destination node 120, overall latency may be preserved while reducing the number of required signal lines to any given node. Rather than simultaneously transmitting the various pieces of information that are to be communicated from the originator node 110 to the destination node 120, the communication of these pieces, or segments, of information may be time dispersed as well (i.e., all bits of information across a given channel need not communicate portions of a given message in parallel with communication of corresponding portions on other channels). A plurality of single-link (or dedicated) communication paths across which a single message is divided may be considered a virtual link 180.

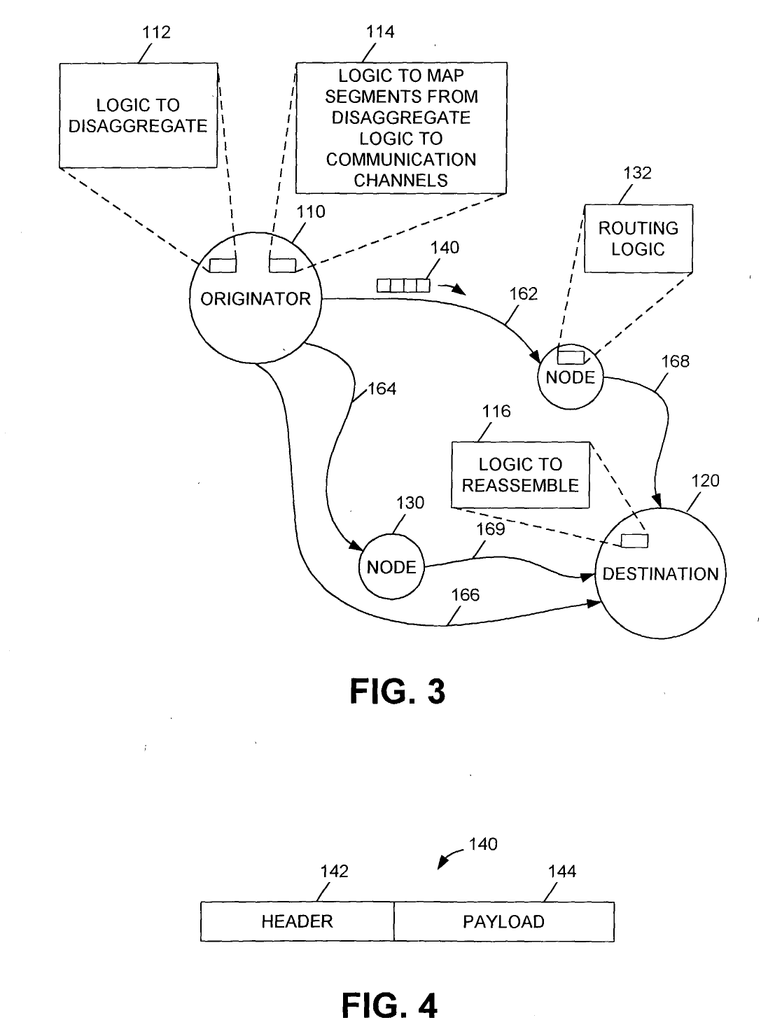

In order to implement the unique communication methodology of the preferred embodiment, various logic components are desired. In this regard, reference is made briefly to FIG. 3, which illustrates an originator node 110, a destination node 120, several intermediate nodes 130, and inter-connecting communication links 162, 164, 166, 168, and 169. It will be appreciated that numerous other similar communication links and nodes may be provided, but are not illustrated in order to simplify the illustration of FIG. 3. As is further illustrated, one communication link 164 may extend directly between the originator node 110 and destination node 120, while other communication links may pass through intermediate nodes 130.

FIG. 3 also illustrates various logic blocks associated with the originator node, an intermediate node 130, and destination node 120. It should be appreciated by the discussion provided herein that the various illustrated logic blocks may be included as a part of every single node in the system. In this regard, and as mentioned above, nodes are designated as “originator,” “intermediate,” and “destination” merely for the context of a single message delivery. At different times and in the context of different messages, a given node may assume different roles (e.g., originator versus destination).

A first logic block 112 is a block configured to disaggregate or split an information packet into a plurality of fragments that are to be communicated from the originator node 110 to the destination node 120. In this regard, it is assumed that a certain amount of information is desired to be communicated from the originator node 110 to the destination node 120. The contents of this information or the purpose of the communication is immaterial to the present invention, and therefore need not be described herein. For purposes of description, this information may be viewed or considered as a single packet of information. The term “packet” here is not intended to connote any definitive structure, format, or protocol, but merely an identifiable quantity of data or information to be communicated. The logic 112 that splits this information into a plurality of individually-communicable data segments merely parses up the information into smaller information segments that can be rapidly communicated over single communication links (e.g., 162, 164, 166). In accordance with one embodiment, the information packet may be divided or split into “flits.” A “flit” is merely a term used to describe the smallest block of information that may be communicated across a given link. Of course, the actual size comprising a given flit may vary from system to system, depending on the design constraints of a particular system.

Once the information packet has been split into various data segments, another logic block 114 operates on the various data segments to map the data segments to individual communication links for communication to the destination node 120. In a preferred embodiment, there is a one-to-one mapping. In this respect, if there are thirty-two communication links extending from the originator node 110 to the destination node 120, then the information packet will be divided into thirty-two separate chunks for communication thereacross. However, in other embodiments, the information packet may be divided into a larger number of data segments than the corresponding number of communication links. In yet a further embodiment, the information packet may be divided into a fewer number of data segments than there are communication links across which to communicate the data. Regardless of the particular implementation, a logic segment 114 is provided to map the individual data segments onto communication links.

For intermediate nodes 130 that are interposed along a communication path between the originator 110 and destination node 120, routing logic 132 is provided to ensure and maintain a continued and proper routing of data packets 140 from the originator node 110 to the destination node 120. As would be described in more detail in connection with FIG. 4, each data packet 140, which communicates a data segment, preferably comprises a header portion 142 and payload portion 144. The header portion preferably contains information that is used by the routing logic 132 to ensure proper routing and communication of the data packet 140 to the destination node 120. By way of example, in one embodiment, a destination address of the destination node 120 may be embodied in the header information, and an originator address of the originator node.

In such a system, the routing logic 132 may be configured to operate in a fashion similar to routers that are well-known in networked computer systems, such that data packets may be appropriately “steered” during communication. In an alternative embodiment, the header information provided in a given data packet 140 may specify an entire communication path between an originator node 110 and destination node 120. In this regard, the communication path may define every single intermediate node on the given data path between the originator node 110 and destination node 120. Accordingly, there are various implementations that may be embodied in the routing logic 132, and the various implementation details would be appreciated and understood by persons skilled in the art. In one such embodiment, the routing logic may include a mechanism (implemented in hardware, software, firmware, or a mixture thereof) that evaluates the header portion of a data segment to determine a communication link across which to route the data segment.

Finally, reassembly logic 116 is provided. This reassembly logic 116 operates to receive individual data packets that are communicated to the destination node 120 and reassemble from these individual data packets 140 the information packet that was formulated at the originator node 110 for communication to the destination node 120. Again, with brief reference to FIG. 4, a given data packet 140 may comprise a header portion 142 and payload portion 144. The payload portion 144 contains the data segment (or flit of data) that has been disaggregated from the information packet to be communicated. The header portion 142 may comprise a variety of information, depending upon the particular system, design constraints, and other factors which are not pertinent to an understanding of the present invention. In one embodiment, the header portion 142 may indicate the originator.

For example, if a given information packet is divided into thirty-two data segments, each data segment may form the payload portion of thirty-two different data packets. The destination node may determine the sequence by the link on which the data fragment arrived. The reassembly logic at the destination node 120 may utilize such a sequence number in reassembling the payload of the various data packets into a proper order so that the reconstructed information packet is the same as that transmitted from the originator node 110. In an alternative embodiment, the reassembly logic may simply be configured to assemble an information packet from the payload portion of the received data packets in the order that the data packets are received at the destination node 120. Such an embodiment presumes that the data packets will be received in a proper order, and in such an embodiment no sequence number is provided in the header portion 142.

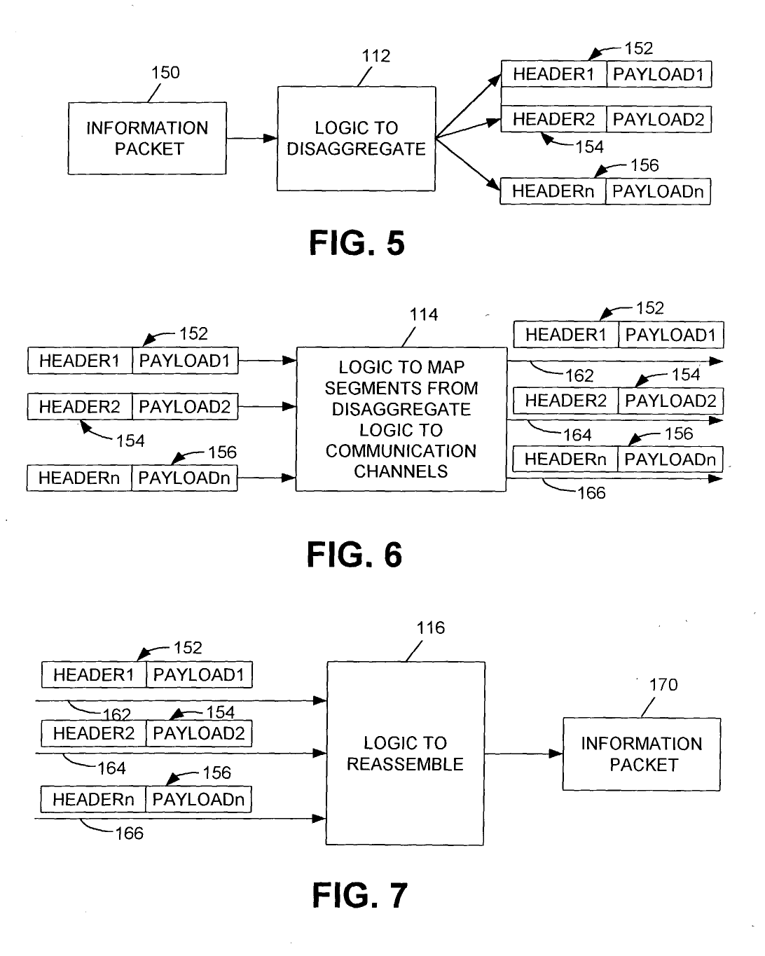

To more particularly, or graphically, illustrate the concepts of the data disaggregation, the mapping function, and the reassembly logic, according to an embodiment of the present invention, reference is made briefly to FIGS. 5, 6, and 7, respectively. In this regard, FIG. 5 is a diagram which illustrated the operation of an embodiment of the disaggregation logic 112 in operating upon an information packet 150 to produce a plurality of data packets 152, 154, and 156. In a preferred embodiment, each of these data packets 152, 154, and 156 includes a header portion and a payload portion. The information of the information packet 150 that is to be communicated to a destination node is embodied in the respective payload portions of these data packets. As illustrated in FIG. 6, these data packets 152, 154, and 156 are operated upon by the mapping logic 140 such that each of the data packets 152, 154, and 156 are communicated across a given, predefined communication link 162, 164, and 166, respectively. As illustrated in FIG. 7, these data packets 152, 154, and 156, which are carried on communication paths 162, 164, and 166, respectively, are operated upon by the reassembly logic 116, to reproduce an information packet 170. As described above, the contents of the information packet 170 are preferably identical to the contents of the information packet of 150 (FIG. 5).

The logic blocks 112, 114, 116, and 132 may be implemented as modules, segments, or portions of code which include one or more executable instructions for implementing specific logical functions or steps in the process, and alternate implementations are included within the scope of the preferred embodiment of the present invention.

The foregoing has merely described one embodiment or implementation. It will be appreciated, however that various alternatives may be implemented, consistent with the scope and spirit of the invention. In this regard, it should be noted that disaggregation logic and mapping logic will play different roles in header creation, depending on the routing method used. In one embodiment, the disaggregation logic may simply maintain the destination ID, while the mapping logic makes the appropriate header once it maps a segment to a path. Alternatively, the destination ID may be all that is needed in the header, with the disaggregation logic being configured to determine all remaining information.

What has been described is a unique architecture for a nodal computer system that can effectively and efficiently communicate information from one node to another. Advantageously, the overall number of communication channels is reduced, while maintaining low latency in communications. Various implementation details, particularly with regard to the logic for implementing the functions described herein, will be appreciated by persons skilled in the art, and need not be described herein in order to gain an understanding of the concepts and teachings of the present invention.

Accordingly, from the foregoing discussion, it will be appreciated that the preferred embodiment is directed to an innovative networking method that combines the reduced network diameter of high-dimensional topologies with the high bandwidth of low dimensionality. High dimensionality indicates that components on the network directly connect to many other components on the network. In this way, the incidence of hopping through components to reach a desired component is reduced, lowering network diameter. Normally, this is done at the expense of bandwidth between components, as the cost to maintain wide data paths is often prohibitive.

The preferred embodiment dispenses with the limitations of dimensionally high topologies by combining a small fraction of the resources from a large number of components to provide a wide communication path between any two components. Transactions are fragmented by a originator node and dispersed along many independent paths through many separate components (e.g., intermediate nodes), which then serve to coalesce the transaction at a destination node.

Since the transaction follows many independent paths, the arrival of the transaction fragments at the destination node may be uncorrelated in time. Thus, information may be included with transaction fragments (e.g., sequence number) to enable corresponding fragments to be coalesced at the destination node.

The originator node, transaction order, and fragment position are preferably discernable to the destination node and the path to the destination node is preferably discernable by any intermediate node. Implicit methods to communicate generally require less information to be carried by the links, reducing bandwidth consumption and shortening latency. For instance, transaction order can be implied from fragment order if fragments from an originator follow the same path and maintain order along that path. Fragment position can be implied by the ordinal number of the link receiving the fragment if only fragments for that position arrive at that link.

Such restrictions still allow for a minimum of coordination between components. For instance, ordering of originators at a link is not restricted; fragments of a first and second transaction from a particular originator will arrive at a destination node in the same first and second order; however, any number of fragments from other originators can intercede between the first and second transaction fragments.

The identities of the originator node, as well as the path to the destination node, remain to be communicated; if a number of consecutive fragments have the same path-determining information, only the fragment should need to be communicated. One method to communicate path-determining information is to provide fragments with component identifiers, such that each component must determine which channel is to be used next along this path. Another method would be to determine the sequence of links in a path (pathway) at the originator, communicating this determination along with the fragment. The destination node can discern the originator node by examining the reverse of the pathway. Note that the current link is implicit and does not need to be communicated; which link is implicit changes with each step in the path.

In certain embodiments, a large number of components can be accommodated with a relatively small number of links per component, with only one or two intermediate components in any pathway. Specifying the pathway requires only one or two extra bytes per fragment; fragments are typically ten bytes in length.

It should be further appreciated that a fault-tolerant protocol may be easily implemented. In this regard, the disaggregation and mapping logic can readily be used to avoid any channel or component that has a fault with some coordination with reassemble logic. Any one working path between the originator and destination node can be used to communicate control type messages that would be used for this coordination. Performance is only fractionally degraded, if at all, as a failed path is only 1-of-many paths used in a virtual link and may be replaceable or modifiable. A fault of any node or path will potentially affect many originator/destination pairs, but only by a small amount.

1. A computer system having a plurality of nodes interconnected by a plurality of dedicated communication links, each node comprising:
logic configured to disaggregate an information packet to be communicated to another node into a plurality of individually-communicable segments;
logic configured to map the plurality of segments onto at least two of the plurality of communication links; and
logic configured to reassemble the plurality of segments separately received over the plurality of communication links into a single information packet.

2. The computer system of claim 1, wherein the individually-communicable segments each comprise at least one flit.

3. The computer system of claim 1, wherein each communication link comprises at least one intermediate node between a node that originates the information packet and a destination node.

4. The computer system of claim 3, wherein the intermediate node comprises routing logic configured to route a received segment toward a destination node.

5. The computer system of claim 4, wherein the routing logic comprises a mechanism configured to evaluate a header portion of the received segment.

6. The computer system of claim 1, wherein each of the individually-communicable segments comprise a header portion and a payload portion.

7. The computer system of claim 6, wherein the header portion comprises an identification of a destination node.

8. The computer system of claim 6, wherein the header portion comprises an identification of a communication path, extending between a node that originates the segment and a destination node, across which the segment is to travel.

9. The computer system of claim 1, wherein the logic configured to reassemble further comprises logic for evaluating a sequence number in a portion of a segment.

10. The computer system of claim 1, wherein the logic configured to reassemble further comprises logic for reassembling the information packet based upon an order in which individual segments are received.

11. A computer system having a plurality of nodes interconnected by a plurality of dedicated communication links, each node comprising:
means for disaggregating an information packet to be communicated to another node into a plurality of individually-communicable segments;
means for mapping the plurality of segments onto at least two of the plurality of communication links; and
means for reassembling the plurality of segments separately received over the plurality of communication links into a single information packet.

12. A method for communicating an information packet from an originator node to a destination node, in a computer system having a plurality of nodes interconnected by a plurality of communication links, comprising:
splitting the information packet into a plurality of data segments;
mapping the data segments to at least two of the plurality of communication links extending between the originator node and the destination node; and
reassembling the information packet at the destination node.
